(19) United States
(12) Patent Application Publication
(10) Pub. No.: US 2015/0200067 A1
(43) Pub. Date: Jul. 16, 2015

(54) CERAMIC CHIP FUSE WITH OFFSET FUSE ELEMENT

(71) Applicant: LITTELFUSE, INC., Chicago, IL (US)

(72) Inventor: Olga Spaldon-Stewart, Des Plaines, IL (US)

(73) Assignee: LITTELFUSE, INC., Chicago, IL (US)

(21) Appl. No.: 14/593,387

(22) Filed: Jan. 9, 2015

Related U.S. Application Data
(60) Provisional application No. 61/925,862, filed on Jan. 10, 2014.

(51) Int. Cl. H01H 37/76; H01H 37/32; H01H 69/02; H01H 37/04

(52) U.S. Cl. CPC H01H 37/76; H01H 37/04; H01H 37/32; H01H 69/02

(57) ABSTRACT

An improved ceramic chip fuse with offset fuse element comprising a plurality of non-conductive layers; a fuse element disposed between ones of the plurality of non-conductive layers such that more non-conductive layers are above the fuse element than below the fuse element relative to a vertical axis of the fuse; first and second conductive terminals electrically connected to the fuse element to connect the fuse to a circuit to be protected and a source of power.

### CROSS-REFERENCE TO RELATED APPLICATIONS

This application claims the benefit of U.S. Provisional Patent Application Ser. No. 61/925,862, filed Jan. 10, 2014, the entirety of which application is incorporated by reference herein.

### FIELD OF THE DISCLOSURE

This disclosure relates generally to the field of circuit protection devices and more particularly to ceramic chip fuses.

### BACKGROUND OF THE DISCLOSURE

Fuses, which are commonly used as circuit protection devices, provide electrical connections between sources of electrical power and circuit components that are to be protected. Chip fuses, also known as thin-film fuses, surface-mount fuses, or SMD fuses, are one type of fuse that includes a fusible element disposed between non-conductive layers of material. Conductive terminals are connected to each end of the fusible element to provide a means of connecting the fuse within a circuit. Upon the occurrence of a specified fault condition in a circuit, such as an overcurrent condition, the fusible element can melt, or otherwise separate, to interrupt current flow in the circuit path. Protected portions of the circuit are thereby electrically isolated and damage to such portions may be prevented or at least mitigated.

Chip fuses are often used to provide protection to components on a printed circuit board. As will be appreciated, real estate on printed circuit boards is very limited. Furthermore, chip fuses are often used in high voltage, high current, and/or high temperature environments necessitating the need for stability and performance reliability.

Some chip fuses are mounted on and/or enclosed in a rigid substrate (e.g., FR4, or the like) to provide support to the fuse and ensure that when the fuse link interrupts in response to a fault condition, the fuse body is not ruptured. Rupturing of the fuse body can cause damage to the components to be protected as well as adjacent components on the printed circuit board. The rigid substrate also adds additional size as well as cost to the chip fuse.

Thus, there is a need for a chip fuse that provides high voltage and current interruption capabilities and is reliable for use in high temperature environments, but which is small enough to satisfy design constraints for printed circuit board use.

### SUMMARY

In accordance with the present disclosure, a fuse is disclosed. The fuse may include a plurality of non-conductive layers, a fuse element disposed between ones of the plurality of ceramic layers such that more ceramic layers are above the fuse element than below the fuse element in a first direction, and first and second conductive terminals electrically connected to the fuse element to connect the fuse to a circuit to be protected and a source of power.

In some examples, a ceramic chip fuse comprised of multiple ceramic layers in which a fuse element is placed off-center in the vertical axis is provided. In some examples, the fuse element is positioned below the centerline of the fuse with respect to the vertical axis such that that the thickness of ceramic above the fuse element is greater than the thickness of ceramic below the element. The additional ceramic thickness above the element provides that the fuse may reliably interrupt high voltages. Particularly, the additional ceramic thickness above the element provides that the fuse may reliably interrupt high voltages without rupturing.

### BRIEF DESCRIPTION OF THE DRAWINGS

By way of example, specific embodiments of the disclosed device will now be described, with reference to the accompanying drawings, in which:

FIG. 1 is a block diagrams of a chip fuse;

FIG. 2 is an example of the chip fuse of FIG. 1 that ruptured due to an overvoltage condition;

FIGS. 3-5 are illustrations of chip fuses with the fuse element disposed below the centerline of the vertical axis of the fuse;

FIG. 6 is a flow diagram of a method for manufacturing a chip fuse, all arranged in accordance with at least some embodiments of the present disclosure.

FIG. 7 is a flow diagram of an additional method for manufacturing a chip fuse, all arranged in accordance with at least some embodiments of the present disclosure.

### DETAILED DESCRIPTION

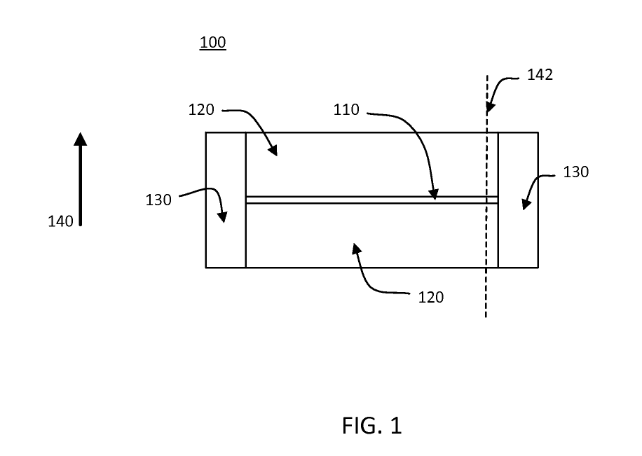

FIG. 1 is a side view of a chip fuse 100 manufactured without a rigid substrate. The chip fuse 100 includes a fuse element 110 disposed between non-conductive layers 120 and electrically connected to conductive terminals 130. As depicted, the fuse element 110 is centered between the non-conductive layers 120 in a first direction 140 (referred to herein as the vertical direction), which corresponds to the vertical axis 142 of the fuse. The fuse element 110 may extend horizontally across the non-conductive layers 120 in the form so as to make contact with each of the conductive terminals 130. The fuse element 110 contacts the conductive terminals 130 to firm an electrical connection through the chip fuse 100. The chip fuse 100, or the fuse element 110, may be formed of one or more layers of electrically conductive material. Also, the non-conductive layers 120 may include one or more inner layers, such as a first layer, which may comprise a coating of silver or a silver alloy. The fuse element 110 may be selected to have a desired diameter, width, and configuration so as to provide a predetermined response to current and voltage. Alternatively, the fuse element 110 may be a deposited film or other suitable material having predetermined characteristics.

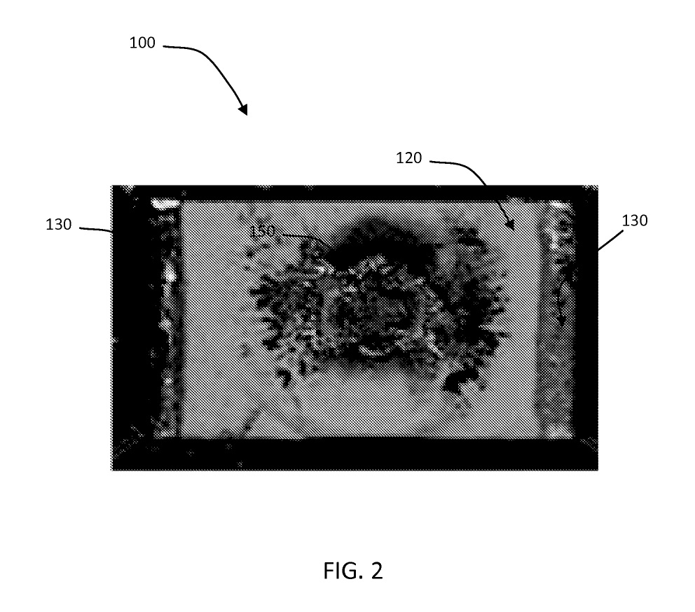

FIG. 2 is a top view (e.g., the first direction 140 is coming out of the page) of an example of the chip fuse 100. One of the non-conductive layers 120 (e.g., the top layer) is shown as well as the conductive terminals 130. The chip fuse 100, however, may not provide reliable protection at high voltages. More specifically, high voltages may cause the chip fuse 100 to rupture (e.g., 150), which can cause damage to the circuit being protected as well as surrounding components. For example, chip fuses similar to the chip fuse 100 may rupture above 63 volts. As such, these fuses are unsuitable for use in environments where the voltage is higher than 63 volts.

In general, the present disclosure provides a ceramic chip fuse comprised of multiple ceramic layers in which a fuse element is placed off-center on the vertical axis. Said differently, the present disclosure provides layers of non-conductive material (e.g., ceramic) stacked with a fuse element disposed off-center in the vertical direction of the stack. In some examples, the fuse element is positioned below the centerline of the fuse with respect to the vertical axis such that that the thickness of ceramic above the fuse element is greater than the thickness of ceramic below the element. The additional ceramic thickness above the element provides that the fuse may reliably interrupt high voltages.

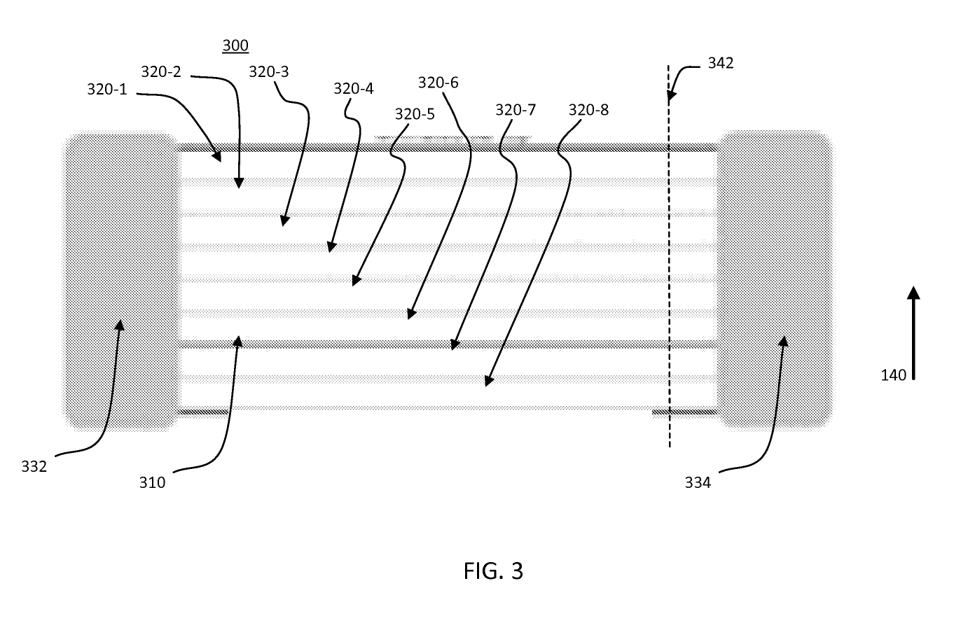

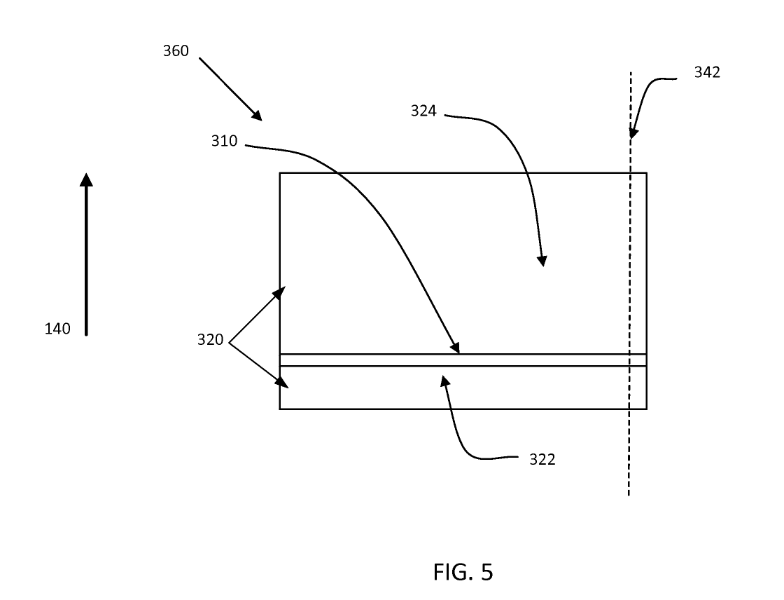

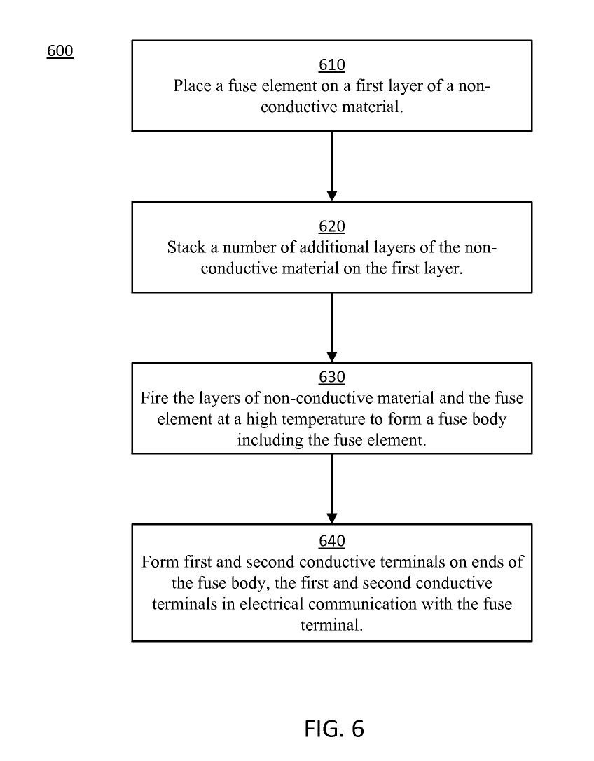

FIG. 3 is a side view of a chip fuse 300, arranged according to at least some embodiments of the present disclosure. The chip fuse 300 includes a fuse element 310 disposed between non-conductive layers 320. In some examples, the non-conductive layers 320 may be ceramic, a ceramic-glass compound, or an LTCC ceramic-glass mixture. In some examples, the non-conductive layers 320 may be referred to as “green-tape ceramic layers,” which are co-fired with the fuse element 310 during manufacturing (e.g., refer to FIGS. 5 and 6.)

The chip fuse 300 is depicted including layers 320-1 to 320-8, which the fuse element 310 disposed between (e.g., “sandwiched” between) layers 320-6 and 320-7. Said differently, the fuse element 310 is disposed between the non-conductive layers 320 such that more non-conductive layers 320 are above the fuse element 310 than below. That is, the fuse element 310 is disposed below the centerline of the vertical axis 342 of the chip fuse 300.

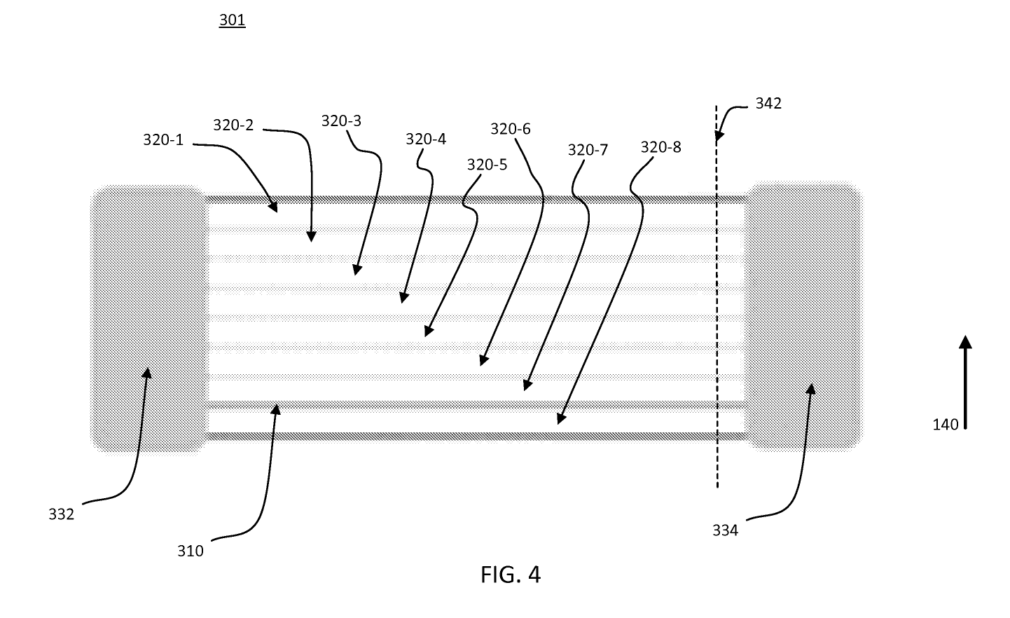

FIG. 4 is a side view of a chip fuse 301, arranged according to at least some embodiments of the present disclosure. This chip fuse 301 includes the fuse element 310, the non-conductive layers 320, and the terminals 330 (e.g., first and second terminals 332 and 334). As depicted, the fuse element 310 is disposed between the layers 320-7 and 320-8. Said differently, the fuse element 310 is disposed between the non-conductive layers 320 such that more non-conductive layers 320 are above the fuse element 310 than below. That is, the fuse element 310 is disposed below the centerline of the vertical axis 342 of the chip fuse 301.

In general, the fuse element 310 may be any material having desirable electrically conductive properties. In some examples, the fuse element 310 may be nickel, copper, silver, gold, tin, or an alloy or mixture comprising, nickel, copper, silver, gold, or tin. With some examples, the fuse element 310 may have a thickness between 0.02 and 5 mils. Additionally, with some examples, the non-conductive layers 320 may be ceramic, such as, for example, alumina. With some examples, the non-conductive layers 320 may have a thickness between 0.5 and 20 mils and the terminals may be formed from any conductive materials, such as, for example, silver, copper, tin, nickel, or any combination of such materials.

It is to be appreciated, that the number of layers depicted in FIGS. 3 and 4 is done to facilitate understanding and is not intended to be limiting. More specifically, various embodiments may include more or less non-conductive layers 320 than depicted. Furthermore, as will be appreciated, it may not be possible to distinguish between the non-conductive layers 320 in the manufactured device. More specifically, some examples provide that the non-conductive layers 320 are formed from a low temperature co-fired ceramic (LTCC) material. The LTCC material is co-fired with the fuse element and once fired, the non-conductive layers 320 combine to essentially become a single layer such that they are indistinguishable from each other. However, as described above, the fuse element is positioned in the vertical axis (e.g., 342) such that more LTCC material corresponding to the non-conductive layers 320 is above the fuse element than below the fuse element. In some examples more than 65% of the material corresponding to the layers will be above the fuse element than below. With some examples, between 65% and 99% of the material corresponding to the layers will be above the fuse element than below.

FIG. 5 illustrates an example of a fuse body 360 formed by firing the non-conductive layers 320 and the fuse element 310. As can be seen, the fuse body includes a first portion of non-conductive material 322, which is disposed below the fuse element 310 and a second portion of non-conductive material 324, which is disposed above the fuse element 310. The first portion of non-conductive material 322 corresponds to the layers (e.g., the layers 320-7 to 320-8, the layer 320-8, or the like) disposed below the fuse element 310 in the first direction 140 while the second portion of non-conductive material 324 corresponds to the layer(s) (e.g., the layers 320-1 to 320-6, the layers 320-1 to 320-7, or the like) disposed above the fuse element in the first direction 140.

FIG. 6 is a flow diagram of a method 600 for manufacturing a fuse according to some embodiments of the present disclosure. The method 600 may begin at block 610. At block 610, a fuse element may be placed on a first layer of a non-conductive material. For example, the fuse element 310 may be printed on one of the non-conductive layers 320 (e.g., the layer 320-7 or the layer 320-8).

Continuing to block 620, a number of other layers may be stacked onto the first layer. For example, the layers 320-1 to 320-6 are stacked on top of the layer 320-7 in FIG. 4. Additionally, the first layer may be stacked onto one or more layers.

Continuing to block 630, the layers and the fuse element are fired to form a fuse body. For example, the non-conductive layers 320 and the fuse element 310 may be fired to form the fuse body 360 shown in FIG. 5. In some examples, the layers and the fuse are fired at a temperature of between 500 and 1000 degrees Celsius for between 1 minute and 90 minutes. Additionally, other firing processes (e.g., sintering, burn out, or the like) may be performed.

Continuing to block 640, first and second fuse terminals may be formed on the fuse body. For example, the first and second conductive terminals 332 and 334 may be formed on the fuse body 360. In some examples, the materials (e.g., the materials being the first and second fuse terminals formed by dipping and/or plating) may be formed by dipping and/or plating the ends of the fuse body.

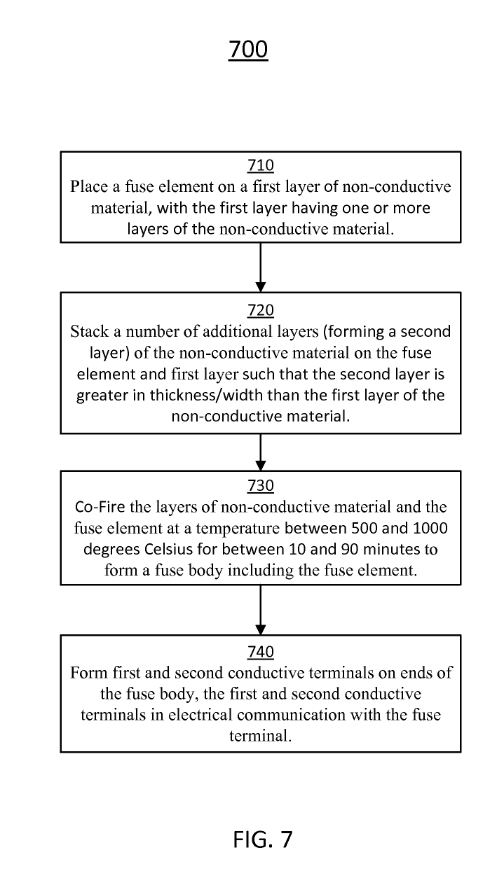

FIG. 7 is a flow diagram of a method 700 for manufacturing a fuse according to some embodiments of the present disclosure. The method 700 may begin at block 710. At block 710, a fuse element may be disposed on a first layer of a non-conductive material, the first layer being at least one or more layers of the non-conductive material. For example, the fuse element 310 may be printed on one or more of the non-conductive layers 320 (e.g., the layer 320-7 and/or the layer 320-8).

Continuing to block 720, a number of additional layers (which form a second layer) may be stacked onto the fuse element and the first layer such that second layer non-conductive material is greater in thickness/width than the first portion of non-conductive material. The additional secondary layers (second layer) and the first layer surround and protect the fuse element. For example, the layers 320-1 to 320-6 are stacked on top of the layer 320-7 in FIG. 4. Additionally, the first layer may be stacked onto one or more layers.

Continuing to block 730, the layers and the fuse element are co-fired using one of a variety of firing processes at a temperature between 500 and 1000 degrees Celsius for between 10 minutes and 90 minutes to form a fuse body. For example, the non-conductive layers 320 and the fuse element 310 may be co-fired to form the fuse body 360 shown in FIG. 5. The temperature and the timing may vary and depend on the materials of the fuse element and the non-conductive material. The firing processes may include sintering, burn out, or the like.

Continuing to block 740, first and second fuse terminals may be formed on the fuse body. For example, the first and second conductive terminals 332 and 334 may be formed on the fuse body 360. In some examples, the materials may be formed by dipping and/or plating the ends of the fuse body.

In view of the forgoing, it is evident that providing a ceramic chip fuse comprised of multiple ceramic layers in which a fuse element is placed off-center on the vertical axis provides that the fuse may reliably interrupt high voltages. Said differently, by providing layers of non-conductive material (e.g., ceramic) stacked with a fuse element disposed off-center in the vertical direction of the stack, such as disposing the fuse element below the centerline of the fuse with respect to the vertical axis such that that the thickness of ceramic above the fuse element is greater than the thickness of ceramic below the element, allows the fuse to ensure that when the fuse link interrupts in response to a fault condition, the fuse body is not ruptured. Moreover, the ceramic chip fuse, as described herein, prevents the fuse body from being ruptured without adding additional size as well as cost to the chip fuse. Hence the ceramic chip fuse provides high voltage and current interruption capabilities and is reliable for use in high temperature environments, but which is small enough to satisfy design constraints for printed circuit board use.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are in the tended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Thus, the claims set forth below should be construed in view of the full breadth and spirit of the present disclosure as described herein.

1. A fuse comprising:
a plurality of non-conductive layers;
a fuse element disposed between ones of the plurality of non-conductive layers such that more non-conductive layers are above the fuse element than below the fuse element relative to a vertical axis of the fuse; and
first and second conductive terminals electrically connected to the fuse element to connect the fuse to a circuit to be protected and a source of power.

2. The fuse of claim 1, wherein the fuse element is disposed below a centerline of the vertical axis of the fuse.

3. The fuse of claim 1, wherein at least 65% of the non-conductive layers are above the fuse element.

4. The fuse of claim 1, wherein the plurality of non-conductive layers have a thickness of between 0.5 mils and 20 mils.

5. The fuse of claim 1, wherein the fuse element has a thickness of between 0.02 and 5 mils.

6. The fuse of claim 1, wherein the first and second conductive terminals are comprised of at least one of silver, copper, tin, nickel or combination of such materials

7. The fuse of claim 1, wherein the non-conductive layers are comprised of at least one of ceramic, a ceramic-glass compound, a low temperature co-fired ceramic (LTCC) material, or combination of such materials.

8. The fuse of claim 1, wherein plurality of non-conductive layers and the fuse element are co-fired to become a single layer.

9. A fuse comprising:
a fuse body comprising:
a first portion of non-conductive material disposed over a fuse element; and
a second portion of non-conductive material disposed under the fuse element, wherein the first portion of non-conductive material is greater than the second portion of non-conductive material; and
first and second terminals disposed on the fuse body and electrically connected to the fuse element.

10. The fuse of claim 9, wherein the fuse element is disposed below a centerline of a vertical axis of the fuse.

11. The fuse of claim 9, wherein the first portion is at least equal to or greater than 65% of the non-conductive material disposed over the fuse element and the second portion is at least equal to or less than 35% of the non-conductive material disposed under the fuse element.

12. The fuse of claim 9, wherein the first and second terminals are comprised of at least one of silver, copper, tin, nickel or combination of such materials.

13. The fuse of claim 9, wherein the non-conductive material is comprised of at least one of ceramic, a ceramic-glass compound, a low temperature co-fired ceramic (LTCC) material, or combination of such materials.

14. The fuse of claim 9, wherein the non-conductive material and the fuse element are co-fired to become a single layer.

15. A method of manufacturing a fuse comprising:
placing a fuse element on at least one of a multiplicity of layers of a non-conductive material;
stacking one or more additional layers of the non-conductive material on the at least one of a multiplicity of layers and the fuse element;
firing the at least one of a multiplicity of layers, the one or more additional layers, and the fuse element to form a fuse body; and
adding first and second conductive terminals on ends of the fuse body, the first and second terminals electrical connected to the fuse element.

16. The method of manufacturing of claim 15, further comprising co-firing the at least one of a multiplicity of layers, the one or more additional layers, and the fuse element to form the fuse body at a temperature between 500 and 1000 degrees Celsius.

17. The method of manufacturing of claim 15, further comprising adding the first and second conductive terminals on the ends of the fuse body by one of dipping or plating the fuse body.

18. The method of manufacturing of claim 15, further comprising disposing the fuse element below a centerline relative to a vertical axis of the fuse.

20. The method of manufacturing of claim 15, wherein the first and second conductive terminals are comprised of at least one of silver, copper, tin, nickel or combination of such materials, and the non-conductive material is comprised of at least one of ceramic, a ceramic-glass compound, a low temperature co-fired ceramic (LTCC) material, or combination of such materials.
